(19) United States
(12) Patent Application Publication
(10) Pub. No.: US 2004/0149674 A1
(43) Pub. Date: Aug. 5, 2004

(54) Quiet pill bottle

(76) Inventor: Denis Corr, Hamilton (CA)

Correspondence Address: MARK A. KOCH, KOCH LAW OFFICE, 866 MAIN STREET EAST, HAMILTON, ON, L8M 1L9, CA

(21) Appl. No.: 10/752,696

(22) Filed: Jan. 8, 2004

Related U.S. Application Data
(60) Provisional application No. 60/443,541, filed on Jan. 30, 2003.

(51) Int. Cl. B65D 23/00; A47J 41/02

(52) U.S. Cl. 215/12.1

(57) ABSTRACT

The present invention is a quiet pill bottle which includes a hollow body for receiving pills. The hollow body defines a bottle cavity and includes a bottle opening at a top end and a body inner surface. The quiet pill bottle includes a cap for releasably closing off the opening and a flexible bag like membrane disposed within the bottle cavity, wherein the membrane is for receiving pills therein and preventing impingement of pills onto the body inner surface. The quiet pill bottle alternatively includes an inner lining covering the body inner surface wherein the inner lining is made of a soft pliable spongy material for minimizing noise generated by pills rattling within the pill bottle.

### FIELD OF THE INVENTION

The present invention relates to bottles and more particularly relates to pill bottles designed to prevent noise generated by movement of pills within pill bottles.

### BACKGROUND OF THE INVENTION

Presently pill bottles are generally manufactured from plastic, using either the injection moulding process or the blow moulding process to form the bottles. Several types of different plastics are suitable for making pill bottles and are generally chosen to ensure that the pill bottle has enough rigidity and strength for shipping and dispensing purposes. Unfortunately, the pill bottles are often made from a very hard or rigid plastic and the pills housed within the pill bottles are often coated with a very hard outer substances. Removal of the cotton from the pill bottle after it is received by the customer, allows the pills to freely move around and rattle and generate noise. This is particularly annoying to those who have to carry their pills with them within the pill bottles, as for example with migraine sufferers and others requiring headache or pain medication. At times the noise can become so annoying so as to aggravate the migraine sufferers condition.

Therefore, there is a need for a pill bottle which provides a quiet housing and transportation of pills within pill bottles even after the cotton has been removed. With such a pill bottle the user can comfortably carry the pill bottle with them at all times without the annoying noise associated with the pills rattling and moving around within the bottle.

### SUMMARY OF THE INVENTION

The present invention comprises a quiet pill bottle including:

(a) a hollow body for receiving pills therein, said body defining a bottle cavity and including an opening at one end and a body inner surface;

(b) a means for releasably closing off said opening;

(c) a means for preventing impingement of pills onto a body inner surface.

Preferably wherein said preventing means includes a flexible bag like membrane disposed with said bottle cavity, said membrane for receiving pills therein.

Preferably wherein said membrane is affixed to said body inner surface at an attachment area proximate said bottle opening.

Preferably wherein said bottle opening including a neck portion defining a passageway for the entry and exit of pills.

Preferably wherein said attachment area being a portion of an inner side of said neck portion.

Preferably wherein said membrane being supported entirely at said attachment area preventing a membrane bottom from contacting said body bottom.

Preferably wherein said membrane selected from one of: cellophane, polyethylene, polypropylene, and poly vinyl chloride.

Preferably wherein said neck including an outer threaded portion for receiving a threaded cap thereon for closing off said pill bottle.

Preferably wherein said preventing means includes an inner lining covering said body inner surface wherein said inner lining made of soft pliable spongy material for minimizing noise generated by pills rattling within said pill bottle.

Preferably wherein said inner lining laminated to said body inner surface.

Preferably wherein said inner lining applied to said body inner surface after said pill bottle has been manufactured.

### BRIEF DESCRIPTION OF THE DRAWINGS

The invention will now be described by way of example with reference to the following drawings in which:

FIG. 1 is an upright perspective view of the present invention a pill bottle together with a cap.

FIG. 2 is a cross sectional view taken along lines 2-2 of FIG. 1 showing in cross-section the pill bottle shown in FIG. 1.

FIG. 3 is a cross-sectional view taken along lines 3-3 of FIG. 1 of the pill bottle.

FIG. 4 is an upright perspective schematic view of an alternate embodiment of the present invention, a pill bottle.

FIG. 5 is a cross-sectional view taken along lines 5-5 of FIG. 4 of the pill bottle.

FIG. 6 is a cross-sectional view taken along lines 6-6 of FIG. 4 of the pill bottle.

### DETAILED DESCRIPTION OF THE PREFERRED EMBODIMENT

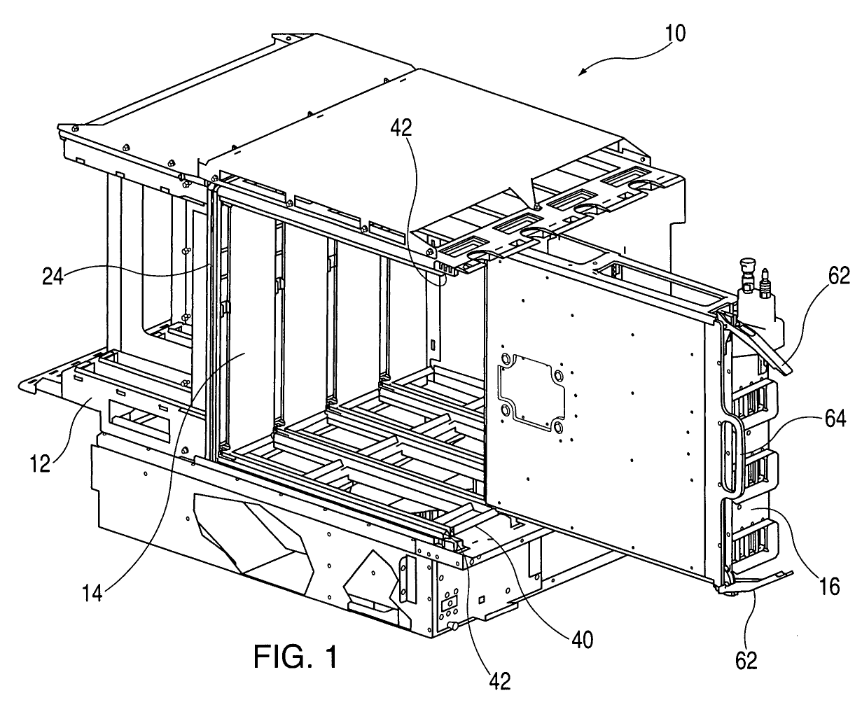

The present invention a pill bottle shown generally as 20 in FIGS. 1, 2 and 3 includes the following major structural components namely body 22, neck 24 having a threaded portion 26 and membrane 28 housed within body 22. Pills 32 shown in FIG. 1 are housed within membrane 28.

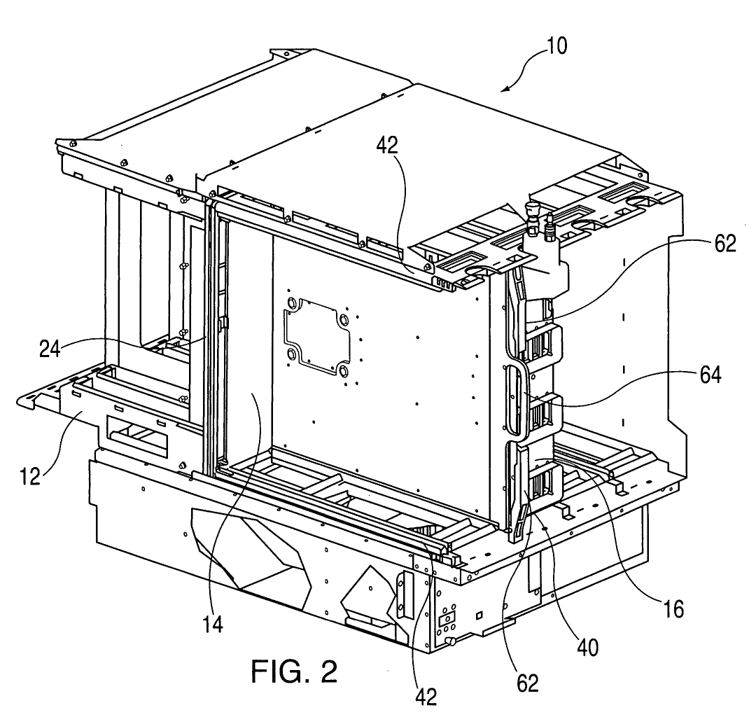

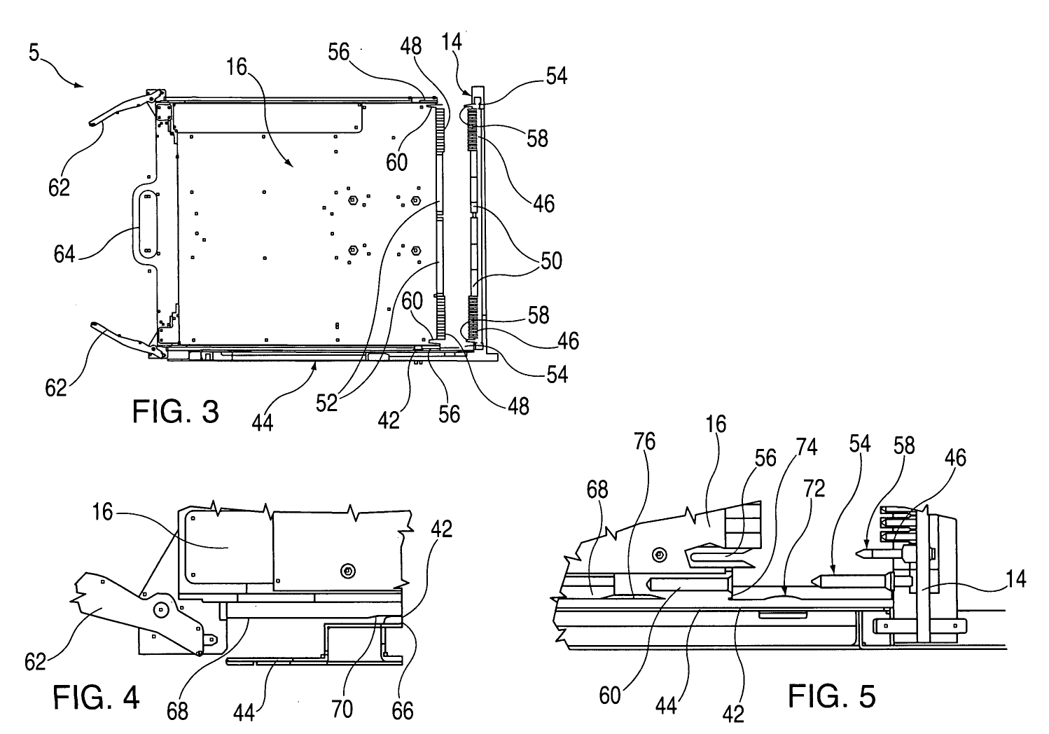

Referring now to FIGS. 2 and 3 in particular which shows pill bottle 20 in cross-sectional view, body 22 defines a bottle cavity 50 and an opening 52. Body 22 also includes a body outer surface 36 and a body inner surface 38. Body outer surface 36 normally has information printed thereon regarding the use and the contents of the bottle. Membrane 28 includes membrane inner surface 44 and membrane outer surface 46. Membrane 28 is attached to body inner surface 38 at attachment area 34 which is near the base of neck 24 of pill bottle 20. Membrane 28 can be made of a thin and flexible plastic such as cellophane or other suitable plastic materials and hangs freely within the cavity defined by body 22 of pill bottle 20. Membrane 28 deforms under the weight of pills 32 housed within membrane 28. Membrane bottom 42 preferably does not come into contact with body bottom 40 to ensure that membrane 28 is free hanging within body 22. The method of attaching membrane 28 to body 22 are those methods known in the art including adhesive attachment with heat and/or adhesive processes and/or ultrasonic welding.

In Use

Pill bottle 20 is designed to hold pills 32 quietly within body 22 of pill bottle 20. This is accomplished through the use of a free hanging membrane 28 which is housed within the cavity defined by body 22. The free hanging membrane 28 is attached at attachment area 34 to the base portion of neck 24 as depicted in FIG. 2. When pills 32 are deposited within pill bottle 20, they come into contact with membrane inner surface 44 of membrane 28 and fall to the bottom portion or membrane bottom 42 of membrane 28 under the force of gravity. Membrane 28 is free hanging and as a result deforms and collapses somewhat around pills 32 thereby minimizing the movement of pills 32 and also providing for a soft pliable and flexible surface on which pills 32 make contact. Therefore, one skilled in the art will note that the weight of pills 32 onto membrane 28 will deform membrane 28 such that it will tend to collapse onto pills 32, thereby preventing their movement and rattling within body 22. Once the cotton has been removed from pill bottle 20, any remaining pills 32 within pill bottle 20 will not be impinging against the hard body inner surface 38 of pill bottle body 22, but rather will be cradled within soft membrane 28 near membrane bottom 42 of pill bottle 20.

Alternate Embodiment

An alternate embodiment to the present invention, namely pill bottle 120 is depicted in FIGS. 4, 5 and 6. Pill bottle 120 includes the following major elements, namely body 122, neck 124, threaded portion 126 and inner lining 128. Further depicted cap 130 which threads onto threaded portion 126 of pill bottle 120. There are many methods known in the art for connecting cap 130 onto neck 124 which do not use threads as depicted here which are contemplated methods of connecting cap to neck 124 and is within the scope of this invention.

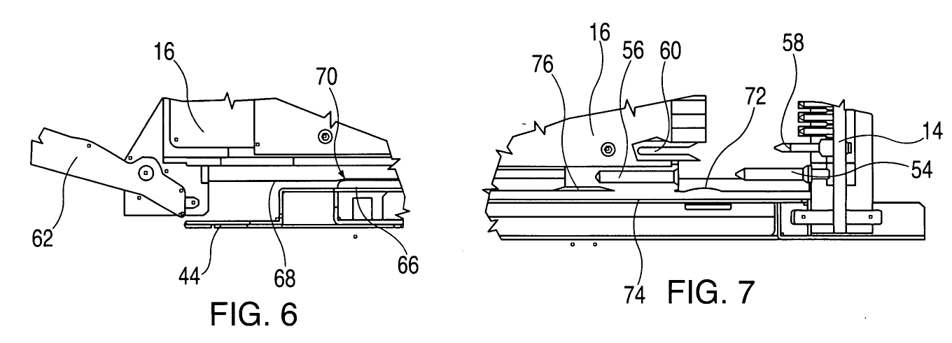

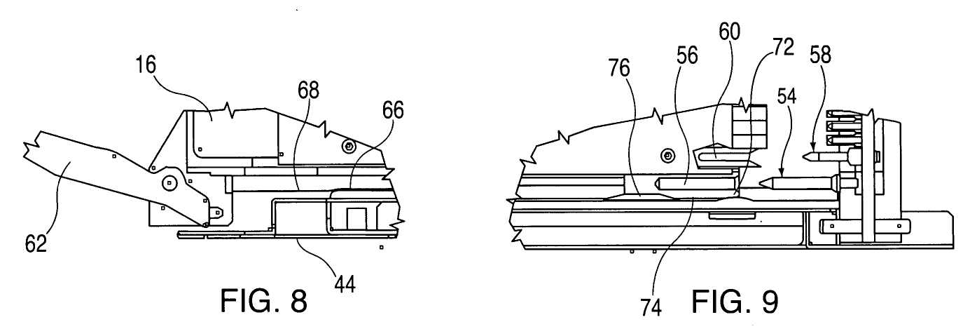

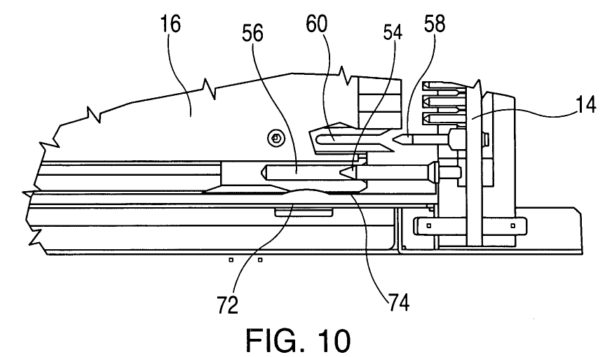

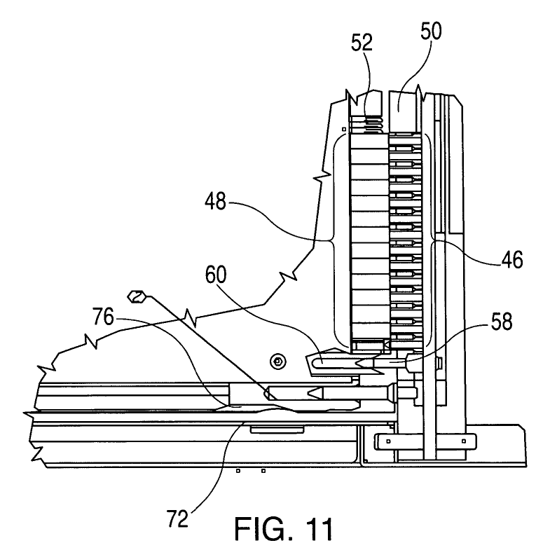

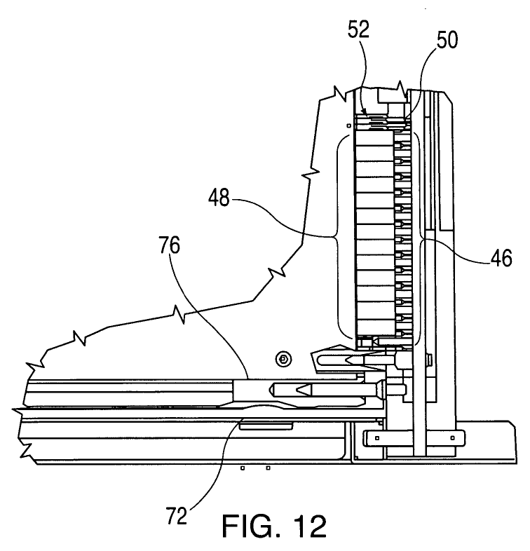

Now referring to FIGS. 5 and 6 which are cross-sectional views of the alternate embody, namely pill bottle 120 having a body 122 including a body inner surface 138 and a body outer surface 136. Body outer surface 136 normally has printed thereon information regarding the contents and the use of the pills 132 which are found within pill bottle 120.

Inner lining 128 includes inner lining inner surface 144 and inner lining outer surface 146 wherein inner lining 128 is continuously adhered and connected to body inner surface 138 together with inner lining outer surface 146. In this manner inner lining 128 lines the entire inner surface of body 122 up until the base portion of neck 24 roughly as depicted in FIG. 5. Inner lining 128 is made out of soft pliable rubbery and/or spongy type material which holds pills 132 proximate inner lining bottom 142 of body bottom 140. The soft pliable, flexible spongy like inner lining 128 minimizes the rattling and noise generated by pills 132 impinging upon the inner lining inner surface 144 of pill bottle 120.

In Use

Pills 132 deposited into pill bottle 120 come in contact with inner lining 128 of pill bottle body 122. Inner lining 128 covers substantially the entire inner surface of body 128 thereby providing a soft spongy pliable surface onto which pills 132 impinge. Inner lining 132 are chosen such that the pills are softly housed within body 122. The characteristics of inner lining 128 is designed so as to minimize the noise and rattling of pills 132 within body 122 of pill bottle 120.

It should be apparent to persons skilled in the arts that various modifications and adaptation of this structure described above are possible without departure from the spirit of the invention the scope of which defined in the appended claim.

I claim:

1. A quiet pill bottle comprising:
(a) a hollow body for receiving pills therein, said body defining a bottle cavity and including a bottle opening at a top end and a body inner surface;
(b) a means for releasably closing off said opening;
(c) a means for preventing impingement of pills onto a body inner surface.

2. The quiet pill bottle claimed in claim 1 wherein said preventing means includes a flexible bag like membrane disposed with said bottle cavity, said membrane for receiving pills therein.

3. The quiet pill bottle claimed in claim 2 wherein said membrane is affixed to said body inner surface at an attachment area proximate said bottle opening.

4. The quiet pill bottle claimed in claim 3 wherein said bottle opening including a neck portion defining a passageway for the entry and exit of pills.

5. The quiet pill bottle claimed in claim 4 wherein said attachment area being a portion of an inner side of said neck portion.

6. The quiet pill bottle claimed in claim 3 wherein said membrane being supported entirely at said attachment area preventing a membrane bottom from contacting said body bottom.

7. The quiet pill bottle claimed in claim 2 wherein said membrane selected from one of:
cellophane, polyethylene, polypropylene, and poly vinyl chloride.

8. The quiet pill bottle claimed in claim 4 wherein said neck including an outer threaded portion for receiving a threaded cap thereon for closing off said pill bottle.

9. The quiet pill bottle claimed in claim 1 wherein said preventing means includes an inner lining covering said body inner surface wherein said inner lining made of soft pliable spongy material for minimizing noise generated by pills rattling within said pill bottle.

10. The quiet pill bottle claimed in claim 9 wherein said inner lining laminated to said body inner surface.

11. The quiet pill bottle claimed in claim 9 wherein said inner lining applied to said body inner surface after said pill bottle has been manufactured.
